(19) United States
(12) Patent Application Publication
(10) Pub. No.: US 2011/0032211 A1
(43) Pub. Date: Feb. 10, 2011

(54) SECURE KEYPAD SYSTEM

(75) Inventor: Per Christoffersen, Vaerlose (DK)

Correspondence Address: KNOBBE MARTENS OLSON & BEAR LLP, 2040 MAIN STREET, FOURTEENTH FLOOR, IRVINE, CA, 92614, US

(73) Assignee: BBS DENMARK A/S, Glostrup (DK)

(21) Appl. No.: 12/933,787

(22) PCT Filed: Mar. 27, 2009
(86) PCT No.: PCT/DK2009/050071

§ 371 Date: Oct. 21, 2010

Related U.S. Application Data
(60) Provisional application No. 61/039,959, filed on Mar. 27, 2008.

(30) Foreign Application Priority Data
Mar. 27, 2008 (DK) PA 2008 00449

(51) Int. Cl. G06F 3/045

(52) U.S. Cl. 345/174

(57) ABSTRACT

A secure keypad system has a touch sensitive screen (11) with a plurality of distinct fields (12) on a surface, where each field (12) has an associated input value. A plurality of force sensors (16, 17) are coupled to the screen (11) and arranged at individual force sensor locations to sense individual forces in response to the screen (11) being touched and to generate corresponding individual force signals. Identification means are provided for identifying a field (12) being touched based on the force signals, and generating means are provided for generating the input value associated with the field (12) being touched. An electrically conductive, force transmissive casing (20) encloses the force sensors, the identification means and the generating means.

### FIELD OF THE INVENTION

This invention relates to key pad systems and keyboard systems for use in environments where data security is of high importance, such as when using an automated teller machine (ATM) or for accessing other personal services.

### BACKGROUND OF THE INVENTION

An ATM is a computerized device that provides customers of a financial institution such as a bank with access to financial transactions in a public space without the need for a human clerk or bank teller. On most modern ATMs, the customer is identified by inserting a plastic ATM card with a magnetic stripe or a plastic smartcard with a chip that contains a unique card number and some security information, such as an expiration date. Security is provided by the customer entering a personal identification number (PIN). Using an ATM, customers can access their bank accounts in order to make cash withdrawals (or credit card cash advances) and check their account balances. In ATMs and many other applications security against unauthorised access to the services is of utmost importance. Any input from a user including his PIN must be protected from being revealed to unauthorised persons.

One requirement is that it must be very difficult for unauthorised persons to detect the PIN digits entered. The consequence of this is usually that the electrical signal that are used to sense the keyboard, are protected by tamper-detecting grids. Tamper-detecting grids are becoming more and more expensive because they have to be increasingly sensitive and because the area that has to be covered is increasing, due to the increased security requirements.

U.S. Pat. No. 7,196,694 B2 discloses a touch screen that uses one or more force sensors to determine the location of a touch on the screen.

U.S. Pat. No. 5,241,308 discloses a touch panel supported in discrete locations at its periphery. Strain gauges on the panel respond to forces exerted on the panel by generating signals that are used to determine the position at which a force is applied to the panel. The touch panel may be used as a keypad.

### SUMMARY OF THE INVENTION

The invention provides a keypad system with a touch sensitive screen having a plurality of distinct fields on a surface thereof, where each field has an associated input value. A plurality of force sensors are coupled to the screen and arranged at individual force sensor locations to sense individual forces in response to the screen being touched and to generate corresponding individual force signals. Identification means are provided for identifying a field being touched based on the force signals, and generating means are provided for generating the input value associated with the field being touched. An electrically conductive, force transmissive casing encloses the force sensors, the identification means and the generating means.

This arrangement of the invention ensures that only mechanical parts and components are outside the electrically conductive casing whereas all electrical end electronic components and all related electrical signals are contained within the casing whereby it is ensured that no electrical or electro-magnetic signals relating directly the user's operation of the keypad escape the casing. Data representing the user's operation of the keypad can be transmitted out of the casing in an encoded or encrypted form.

### BRIEF DESCRIPTION OF THE DRAWINGS

FIG. 1 shows a numerical keypad according to the invention;

FIG. 2 shows a cross section through the numerical keypad in FIG. 1 taken along the line II-II; and

FIG. 3 shows a cross section through a alternative embodiment of a numerical keypad according to the invention.

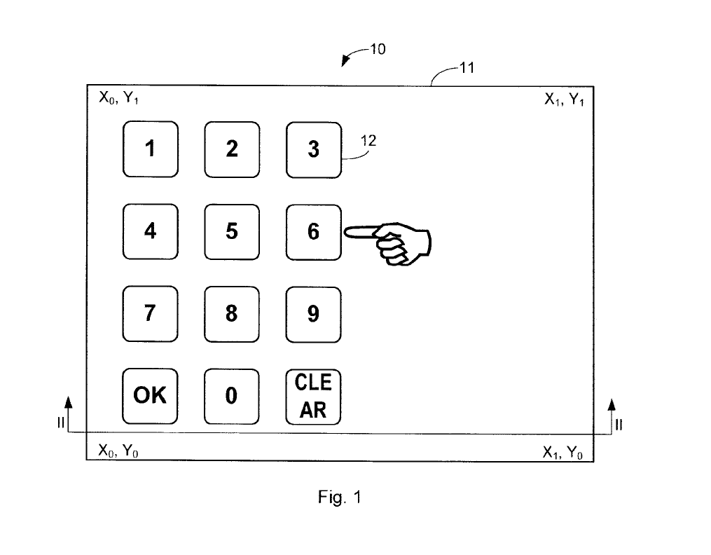

### DETAILED DESCRIPTION OF THE INVENTION

In the following the invention is described using a numerical keypad as an example. However, the invention may also be embodied in an alphanumeric keyboard or other touch sensitive or pressure sensitive input means.

The figures show a numerical keypad 10. The keypad 10 has a top plate 11 made of a rigid material such as metal, glass or a synthetic material, e.g. a fibre-enforced material. The top plate 11 has a user-accessible surface with a plurality of distinct fields 12 defined thereon. The fields 12 can be defined visibly by printing or engraving or other suitable methods. A tactile definition may also be provided for visually impaired persons. In the shown example there are ten fields 12 each identified by a digit 0-9 and two further fields identified by “OK” and “CLEAR”, respectively. The identification by digits 0-9 and “OK” and “CLEAR” is known as such and is used e.g. in ATMs. The digits 0-9 and “OK” and “CLEAR” are input values that are associated with the respective fields.

Below the top plate is a box 13 in which electronic components 14 mounted on a printed circuit board 15. Force sensors 16, 17 such as piezo-electric sensors or strain gauges are mounted on the circuit board 15 and connected to the electronic components 14. The force sensors 16, 17 support the top plate 11 via support members 18, 19 protruding through openings in the box 13. The top plate 11 is supported at three or more, preferably four, locations defining two different directions and thus a two-dimensional coordinate system on the top plate 11. In the shown example the top plate is supported at four locations near the four corners of the top plate which are identified by their X and Y coordinates, (X₀, Y₀), (X₁, Y₀), (X₀, Y₁) and (X₁, Y₁), and individual support members are allocated to each force sensor. The support members 18, 19 support the top plate in locations having the X coordinates X₀ and X₁, respectively. The box 13 is of a material having mechanical properties sufficient for giving proper protection to its content, i.e. a tamper-proof housing. An electrically conductive, force transmissive casing 20 encloses the circuit board 15 with the electronic components 14, and the sensors 16, 17. The casing 20 is preferably a pliable sheet. The electronic components 14 are connectable to the outside of the box 13 as indicated by the arrow 21.

When a user touches a field 12 on the top plate 11 at a point having the coordinates (X, Y) the corresponding force will be transmitted through the four support members to the four force sensors. The individual forces acting on the force sensors depend on the coordinates of the point being touched and the force sensors generate corresponding force signals representing the respective forces on the force sensors. Based on the set of force signals the electronic components 14 calculate the coordinates of the location of the point being touched and thus to identify which one of the fields 12 that has been touched. The electronic components 14 outputs an electrical signal representing the input value associated with the field 12 that has been touched, possibly as a digital signal and in an encrypted form. The top plate 11 thereby functions as a keypad with a touch-sensitive screen that can be used by a user to input numerical values.

The casing 20 constitutes an electrically conducting screen functioning as a Faraday cage enclosing all electrical and electronic components and related electrical signals. The casing 20 provides an effective electromagnetic shield against all outside noise interfering with the keypad system and also prevents electromagnetic signals from escaping outside the casing. Consequently, the stability and reliability of the keypad system is enhanced. The casing 20 is force transmissive whereby forces from the four support members are transmitted through the casing to the respective force transducers. The electrical connection 21 to the outside of the box 13 is made via a leak-proof connection through a proper opening in the casing 20, possibly using a screened cable. In order to prevent detecting the force signals from outside the signals are encoded or encrypted within the corresponding casing 20 so that only encoded or encrypted signals are transmitted via the electrical connection 21 and only encoded or encrypted signals exist outside the casing 20.

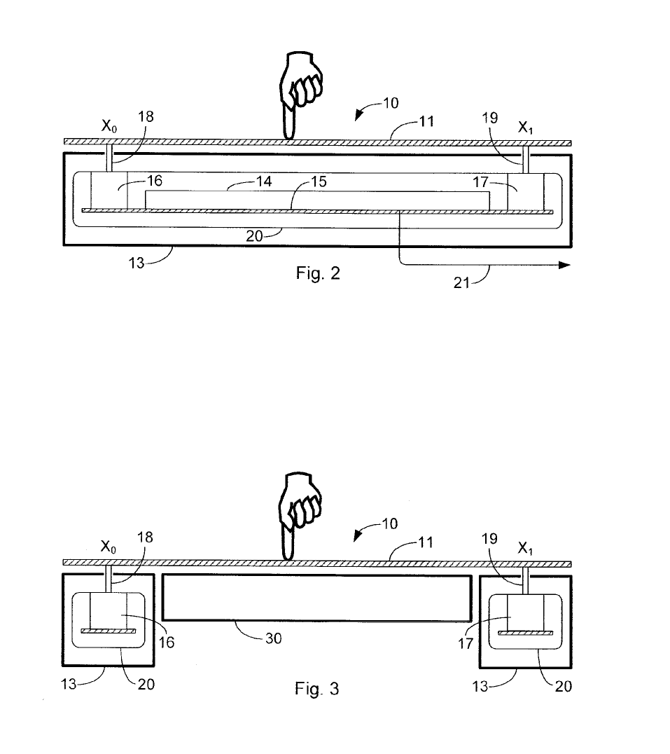

In FIG. 3 is schematically illustrated a numerical keypad 10 in another embodiment of the invention. Like in FIG. 2 the force sensors 16, 17 support the top plate 11 via support members 18, 19, and each force sensor is enclosed in an electrically conductive, force transmissive casing 20. For simplicity only the force sensors, the support members and the casing are shown, but further electronic component are also present like in FIG. 2. In this embodiment the force sensors 16, 17 are arranged in individual boxes 13 placed apart, and the individual force signals generated by the force sensors are preferably transmitted to a common calculating unit or electronic components. In order to prevent detecting the force signals from outside the force signals are encoded or encrypted within the corresponding casing 20 so that only encoded or encrypted signals exist outside the casing.

The arrangement in FIG. 3 with the force sensors in individual boxes leave a space between the boxes and in this embodiment there is arranged a display screen 30 such as a monochrome or colour flat screen liquid crystal display (LCD). The top plate 11 is a transparent touch sensitive screen, e.g. a glass plate, and the display screen is arranged visibly behind the top plate and can display messages and soft keys to the user. Each soft key on the display screen 30 has a corresponding field 12 on the top glass plate 11 which the user can activate by touching. The layout of the fields 12 can thereby be controlled and changed by a computer or other controller of the display screen 30.

In both embodiments in FIGS. 2 and 3 the keypad system has a tamper-responsive system, e.g. included in the electronic components 14, that detects any attempt of physical attack on the system or other unauthorised handling of it. Such system can detect unauthorised attempts of accessing the interior of the boxes or electrical signals contained therein and can include e.g. a mesh of electrically conducting wires (a so-called security foil) that will be interrupted in case of such attempt, and proper protective actions can be initiated, such as erasing the encryption keys used for encrypting the signals obtained from the force sensors. Security foils can act to shield electromagnetic radiation, and a security foil can therefore be used as a (flexible) casing 20. The “box” 13 can also be a tamper proof housing, such as security foil. Other usable systems exist that respond to an attempt of unauthorised handling of the system.

1. A keypad system comprising:
a touch sensitive screen having a plurality of distinct fields on a surface thereof, each field having an associated input value,
a plurality of force sensors coupled to the screen and arranged at individual force sensor locations to sense individual forces in response to the screen being touched and to generate corresponding individual force signals,
identification means for identifying a field being touched based on the force signals,
generating means for generating the input value associated with the field being touched,
an electrically conductive, force transmissive, pliable casing enclosing the force sensors, the identification means and the generating means, and
a tamper-responsive system that can detect tampering of the keypad system or unauthorised attempts of accessing the interior of the casing.

2-14. (canceled)

15. The keypad system according to claim 1 comprising two force sensors and, wherein the fields are arranged in a one-dimensional array.

16. The keypad system according to claim 1 comprising at least three force sensors and, wherein the fields are arranged in a two-dimensional array.

17. The keypad system according to claim 1, wherein the array of fields is indicated on a surface of the touch sensitive screen.

18. The keypad system according to claim 1, wherein the touch sensitive screen is transparent and a display screen for displaying soft keys is arranged visibly behind the touch sensitive screen.

19. The keypad system according to claim 1, wherein the tamper responsive system comprises a mesh of electrically conducting wires that will be interrupted in case of unauthorized attempts of accessing the interior of the casing.

20. The keypad system according to claim 1, wherein the force sensors comprise piezo-electrical sensors.

21. The keypad system according to claim 1, wherein the force sensors comprise strain gauges.

22. The keypad system according to claim 1, wherein the casing comprises a pliable sheet.

23. The keypad system according claim 1, further comprising a box enclosing the force sensors, and support members that protrude through openings in the box and support the screen.

24. The keypad system according to claim 1, wherein the tamper-responsive system is configured to initiate protective actions in case the tamper-responsive system detects tampering of the keypad system or unauthorized attempts of accessing the interior of the casing.

25. The keypad system according to claim 1, wherein encryption keys are used for encrypting the signals obtained from the force sensors, and the encryption keys are erased in case the tamper-responsive system detects tampering of the keypad system or unauthorized attempts of accessing the interior of the casing.

26. The keypad system according to claim 1, wherein the casing does not enclose the screen.

27. The keypad system according to claim 19, wherein said mesh is the casing.
